(19) United States
(12) Patent Application Publication
(10) Pub. No.: US 2025/0151170 A1
(43) Pub. Date: May 8, 2025

(54) CONTROL METHOD AND DEVICE FOR ELECTRIC HEATING APPLIANCE, CONTROLLER, AND ELECTRIC HEATING APPLIANCE

(71) Applicant: SHENZHEN SMOORE TECHNOLOGY LIMITED, Shenzhen (CN)

(72) Inventors: Longjiang WANG, Shenzhen (CN); Yanqin SU, Shenzhen (CN); Feng XIAO, Shenzhen (CN); Meifan XUAN, Shenzhen (CN)

(21) Appl. No.: 19/016,311

(22) Filed: Jan. 10, 2025

Related U.S. Application Data
(63) Continuation of application No. PCT/CN2022/105234, filed on Jul. 12, 2022.

(51) Int. Cl. H05B 3/00; H05B 1/02

(52) U.S. Cl. CPC H05B 3/0019; H05B 1/0202

(57) ABSTRACT

A control method for an electric heating appliance having a first switch module, a second switch module, and a load, a control terminal of the first switch module being accessing a target pulse width modulation (PWM) signal, an output terminal of the first switch module being connected to a control terminal of the second switch module, an input terminal of the second switch module accessing a power supply voltage, an output terminal of the second switch module being connected to the load, and an output signal of the first switch module controlling the second switch module to be in an on state or an off state, includes: determining a first PWM signal, the first PWM signal being a signal loaded onto the control terminal of the first switch module in a state in which the first switch module operates independently, so as to drive the first switch module.

### CROSS-REFERENCE TO PRIOR APPLICATION

This application is a continuation of International Patent Application No. PCT/CN2022/105234, filed on Jul. 12, 2022. The entire disclosure is hereby incorporated by reference herein.

### FIELD

This application relates to the field of operating control technologies of electric heating appliances, and in particular, to a control method and device for an electric heating appliance, a controller, an electric heating appliance, a computer storage medium, and a computer-readable instruction product.

### BACKGROUND

Currently, in a plurality of fields such as medical treatment and beauty, an electric heating appliance such as an electronic atomization device is widely used as a result of a good absorption effect of an aerosol generated by the electric heating appliance.

However, during use, the applicant found that an electric heating appliance in a conventional technology is prone to a temperature control failure such as dry heating or a slow heating speed, which brings a user poor usage experience.

### SUMMARY

In an embodiment, the present invention provides a control method for an electric heating appliance having a first switch module, a second switch module, and a load, a control terminal of the first switch module being configured to access a target pulse width modulation (PWM) signal, an output terminal of the first switch module being connected to a control terminal of the second switch module, an input terminal of the second switch module being configured to access a power supply voltage, an output terminal of the second switch module being connected to the load, and an output signal of the first switch module being configured to control the second switch module to be in an on state or an off state, the method comprising: determining a first PWM signal, the first PWM signal comprising a signal loaded onto the control terminal of the first switch module in a state in which the first switch module operates independently, so as to drive the first switch module to perform on/off switching; obtaining a target operating parameter of the load; determining a second PWM signal based on the target operating parameter, the second PWM signal comprising a signal loaded onto the control terminal of the second switch module to drive the second switch module to be turned on or off, so as to cause the load to operate based on the target operating parameter; and determining and outputting the target PWM signal based on the first PWM signal and the second PWM signal, so as to cause the load to operate based on the target operating parameter, wherein a frequency of the first PWM signal is greater than a frequency of the second PWM signal.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is an application environment diagram of a control method for an electric heating appliance according to one or more embodiments.

FIG. 2 is a schematic flowchart of a control method for an electric heating appliance according to one or more embodiments.

FIG. 3 is a schematic flowchart of a step of determining a first pulse width modulation (PWM) signal according to one or more embodiments.

FIG. 4a to FIG. 4c are schematic diagrams of waveforms of a first PWM signal, a second PWM signal, and a target PWM signal determined in a control method for an electric heating appliance in a structure shown in FIG. 1.

FIG. 5 is a schematic flowchart of a step of determining a second PWM signal based on a target operating parameter according to one or more embodiments.

FIG. 6 is a schematic flowchart of a step of determining a second PWM signal based on a difference between an actual temperature and a target temperature according to one or more embodiments.

FIG. 7 is a schematic flowchart of a step of obtaining an actual temperature of a load according to one or more embodiments.

FIG. 8 is a structural block diagram of a control device for an electric heating appliance according to one or more embodiments.

FIG. 9 is a diagram of an internal structure of a controller according to one or more embodiments.

FIG. 10 is a schematic structural diagram of a circuit of an electric heating appliance according to one or more embodiments.

### DETAILED DESCRIPTION

In an embodiment, the present invention provides a control method and device for an electric heating appliance, a controller, an electric heating appliance, a computer storage medium, and a computer-readable instruction product that can precisely control the electric heating appliance to operate based on a target operating parameter are provided.

In an embodiment, the present invention provides a control method for an electric heating appliance. The electric heating appliance includes a first switch module, a second switch module, and a load. A control terminal of the first switch module is configured to access a target pulse width modulation (PWM) signal. An output terminal of the first switch module is connected to a control terminal of the second switch module. An input terminal of the second switch module is configured to access a power supply voltage. An output terminal of the second switch module is connected to the load. An output signal of the first switch module is configured to control the second switch module to be in an on state or an off state.

The control method for an electric heating appliance includes:
determining a first PWM signal, where the first PWM signal is a signal loaded onto the control terminal of the first switch module in a state in which the first switch module operates independently, to drive the first switch module to perform reliable on/off switching;
obtaining a target operating parameter of the load;
determining a second PWM signal based on the target operating parameter, where the second PWM signal is a signal loaded onto the control terminal of the second switch module to drive the second switch module to be turned on or off, to cause the load to operate based on the target operating parameter; and
determining and outputting the target PWM signal based on the first PWM signal and the second PWM signal, to cause the load to operate based on the target operating parameter, where
the frequency of the first PWM signal is greater than the frequency of the second PWM signal.

A control device for an electric heating appliance is provided. The electric heating appliance includes a first switch module, a second switch module, and a load. A control terminal of the first switch module is configured to access a target PWM signal. An output terminal of the first switch module is connected to a control terminal of the second switch module. An input terminal of the second switch module is configured to access a power supply voltage. An output terminal of the second switch module is connected to the load. An output signal of the first switch module is configured to control the second switch module to be in an on state or an off state.

The control device for an electric heating appliance includes:
a first PWM signal determining module, configured to determine a first PWM signal, where the first PWM signal is a signal loaded onto the control terminal of the first switch module in a state in which the first switch module operates independently, to drive the first switch module to perform reliable on/off switching;
a target operating parameter module, configured to obtain a target operating parameter of the load;
a second PWM signal determining module, configured to determine a second PWM signal based on the target operating parameter, where the second PWM signal is a signal loaded onto the control terminal of the second switch module to drive the second switch module to be turned on or off, to cause the load to operate based on the target operating parameter; and
a target PWM signal determining module, configured to determine and output the target PWM signal based on the first PWM signal and the second PWM signal, to cause the load to operate based on the target operating parameter, where
the frequency of the first PWM signal is greater than the frequency of the second PWM signal.

A controller is provided, including a memory and a processor. The memory stores computer-readable instructions. The computer-readable instructions, when executed by the processor, cause the processor to perform the following steps:
determining a first PWM signal, where the first PWM signal is a signal loaded onto a control terminal of a first switch module in a state in which the first switch module operates independently, to drive the first switch module to perform reliable on/off switching;
obtaining a target operating parameter of a load;
determining a second PWM signal based on the target operating parameter, where the second PWM signal is a signal loaded onto a control terminal of a second switch module to drive the second switch module to be turned on or off, to cause the load to operate based on the target operating parameter; and
determining and outputting the target PWM signal based on the first PWM signal and the second PWM signal, to cause the load to operate based on the target operating parameter, where
the frequency of the first PWM signal is greater than the frequency of the second PWM signal. An electric heating appliance is provided, including:
a first switch module, where a control terminal of the first switch module is configured to access a target PWM signal;
a second switch module, where a control terminal of the second switch module is connected to an output terminal of the first switch module, an input terminal of the second switch module is configured to access a power supply voltage, and the second switch module is configured to be in an on state or an off state under an action of an output signal of the first switch module;
a load, connected to an output terminal of the second switch module;
a controller, where an output terminal of the controller is connected to the control terminal of the first switch module, and the controller is configured to perform the steps of the above control method.

One or more non-volatile storage media storing computer-readable instructions are provided. The computer-readable instructions, when executed by a processor, cause the processor to perform the following steps:
determining a first PWM signal, where the first PWM signal is a signal loaded onto a control terminal of a first switch module in a state in which the first switch module operates independently, to drive the first switch module to perform reliable on/off switching;
obtaining a target operating parameter of a load;
determining a second PWM signal based on the target operating parameter, where the second PWM signal is a signal loaded onto a control terminal of a second switch module to drive the second switch module to be turned on or off, to cause the load to operate based on the target operating parameter; and
determining and outputting the target PWM signal based on the first PWM signal and the second PWM signal, to cause the load to operate based on the target operating parameter, where
the frequency of the first PWM signal is greater than the frequency of the second PWM signal.

To make technical solutions, and advantages of this application clearer, this application is further described in detail below with reference to drawings and embodiments. It should be understood that the specific embodiments described herein are only used for explaining this application, and are not used for limiting this application.

A control method provided in an embodiment of this application may be applied to an application environment shown in FIG. 1. A capacitor C1 in a first switch module 102 passes an alternating current (AC) but blocks a direct current (DC). A diode D1 and a diode D2 control a current flowing direction. An integral circuit composed of a resistor R1, a resistor R2 and a capacitor C2 integrates an inputted target pulse width modulation (PWM) signal. When a voltage of a base of a first switch transistor Q1 satisfies an on condition, the Q1 is turned on, and a collector of the Q1 outputs a current. The current is transmitted to a gate of a second switch transistor Q2 through a resistor R3 in a second switch module 104. A source of the Q2 is connected to a power supply voltage VCC_BAT. A drain of the Q2 is connected to a load 106 that needs to be powered. When an on condition of the Q2 is satisfied, the Q2 is turned on, the power supply voltage VCC_BAT is loaded onto the load (for example, which may be a heating assembly) through a resistor R4 to supply power to the load.

Through adjustment of the frequency of the inputted target PWM signal, an on state of the Q1 may be changed, and durations for which the Q2 is turned on and off may be changed, to change the operating power of the load, and achieve the precise control of the power of the load, so that the load operates at the power satisfying an expected situation. In addition, a first PWM signal (a PWM signal) adapted to an on requirement of the Q1 when the first switch module 102 individual operates is determined. Then, a second PWM signal (a PWM signal) that needs to be loaded by the second switch module 104 may be determined based on the heating power required by the heating assembly. Based on the two, a PMW signal suitable for the Q1 and the Q2 may be further determined, and is used as a target PWM signal finally loaded onto an input terminal of the capacitor C1. In this way, in a case that turn-on and turn-off of each switch tube is stably controlled, the load can be precisely controlled to operate based on a target operating parameter, a problem of an overload or slow rise of the operating power of the load as a result of a failure of the on/off control of the switch transistor can be avoided. For example, when the load is the heating assembly, a problem of dry heating or an excessively slow rise of the temperature of the heating assembly can be avoided.

When the control method provided in this embodiment of this application is applied to an aerosol generation device, the heating power of the heating assembly may be quickly adjusted to satisfy a heating requirement based on the requirement, so that the heating assembly quickly reaches a target temperature. In addition, based on the control method, a problem of dry heating of the heating assembly as a result of loss of control of the first switch module (the first switch transistor Q1 therein) and the second switch module (the second switch transistor Q2 therein) can be avoided.

In a structure shown in FIG. 1, under control of a single PWM wave connected to the base of the Q1, for example, when the PWM wave is directly determined based on an on/off control requirement of the Q2, a risk that the Q1 cannot be accurately turned on exists. To satisfy a temperature requirement, the PWM wave connected to the base of the Q1 needs to be adjusted a plurality of times, to control a frequency at which the load is energized or de-energized, and a temperature test needs to be performed, which results in a delay in reaching the target temperature of the load such as the heating assembly, and low control precision. In addition, the load such as the heating assembly is prone to problems such as the dry heating, which brings a user poor usage experience.

Based on the above, in an embodiment, a control method for an electric heating appliance is provided, which is applied to an electric heating appliance. The electric heating appliance may be an aerosol generation device or another electric heating appliance. When the electric heating appliance is the aerosol generation device, a load may be a heating assembly. A signal outputted by an output terminal of a second switch module is loaded onto the heating assembly, which may determine a heating temperature of the heating assembly. Through execution of the steps of the control method in this embodiment to regulate the above target PWM signal, the heating temperature of the heating assembly can be precisely controlled to stabilize at the target temperature, to avoid a problem of dry heating or excessively slow heating speed of the heating assembly.

As shown in FIG. 1, the electric heating appliance includes a first switch module 102, a second switch module 104, and a load 106. A control terminal of the first switch module 102 is configured to access a target PWM signal. An output terminal of the first switch module 102 is connected to a control terminal of the second switch module 104. An input terminal of the second switch module 104 is configured to access a power supply voltage. An output terminal of the second switch module 104 is connected to the load 106. An output signal of the first switch module 102 is configured to control the second switch module 104 to be in an on state or an off state.

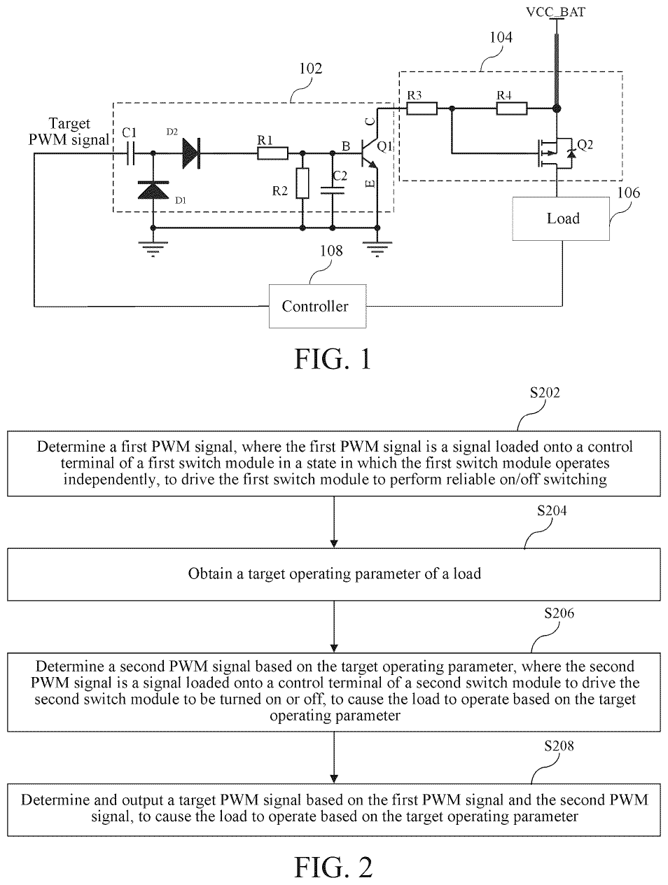

As shown in FIG. 2, a control method for an electric heating appliance includes the following steps:
S202: Determine a first PWM signal, where the first PWM signal is a signal loaded onto a control terminal of a first switch module in a state in which the first switch module operates independently, to drive the first switch module to perform reliable on/off switching. In a case that a circuit structure and a device type selection of the electric heating appliance are determined, a PWM waveform based on which the first switch module is reliably turned on or off may be determined. The PWM waveform is the first PWM signal provided herein.
S204: Obtain a target operating parameter of a load. The target operating parameter is a parameter expected by a user for the load during operation. For example, the target operating parameter may be a target temperature, a target power, a target current, a target voltage, and the like expected by the user.
S206: Determine a second PWM signal based on the target operating parameter, where the second PWM signal is a signal loaded onto a control terminal of a second switch module to drive the second switch module to be turned on or off, to cause the load to operate based on the target operating parameter. In a case that another condition is determined, the actual operating parameter of the load is mainly determined by an electrical signal loaded thereon by an output terminal of the second switch module. Through change the duty cycle of the second PWM signal, durations for which the second switch module is turned on and off may be changed, so as to adjust the power of the electrical signal loaded onto the load.
S208: Determine and output a target PWM signal based on the first PWM signal and the second PWM signal, to cause the load to operate based on the target operating parameter. The frequency of the first PWM signal is greater than the frequency of the second PWM signal. In a case that the frequency of the first PWM signal is less than the frequency of the second PWM signal, a situation in which the first switch module cannot be reliably turned on exists. Therefore, in the above control method, the determining of the first PWM signal and the second PWM signal, and the process of determining the target PWM signal are performed based on the constraint condition.

A first PWM signal that can ensure the stable on/off control of the first switch module is determined, which is configured to be loaded onto a control terminal of the first switch module, to ensure the stable on/off control of the first switch module when independently operating. Then the target operating parameter of the load is obtained, to determine a duty cycle at which the second switch module needs to operate when the load is required to operate based on the target operating parameter, so that it can be ensured that the load stably operates based on the target operating parameter. Based on the determined first PWM signal and second PWM signal, the target PWM signal that satisfies both the stable on/off control of the first switch module and an output power requirement of the second switch module may be determined. The target PWM signal is outputted to the control terminal of the first switch module, to cause the load to operate based on the target operating parameter. To avoid the stable on control of the first switch module, the frequency of the determined second PWM signal is less than the frequency of the first PWM signal. Based on such control implementation, the target PWM signal that can satisfy a stable on/off control requirement of the switch module and a power supply requirement of the load is determined in combination with the two requirements, to avoid problems such as an over-temperature or dry heating and the slow heating speed of the load as a result of a failure during the on/off control of the switch module, thereby improving reliability of operating control of the electric heating appliance.

In an embodiment, the first switch module includes a first switch transistor and a frequency selection network circuit. An input terminal of the frequency selection network circuit is configured to access the target PWM signal, an output terminal of the frequency selection network circuit is connected to an input terminal of the first switch transistor, and an output terminal of the first switch transistor is connected to the control terminal of the second switch module.

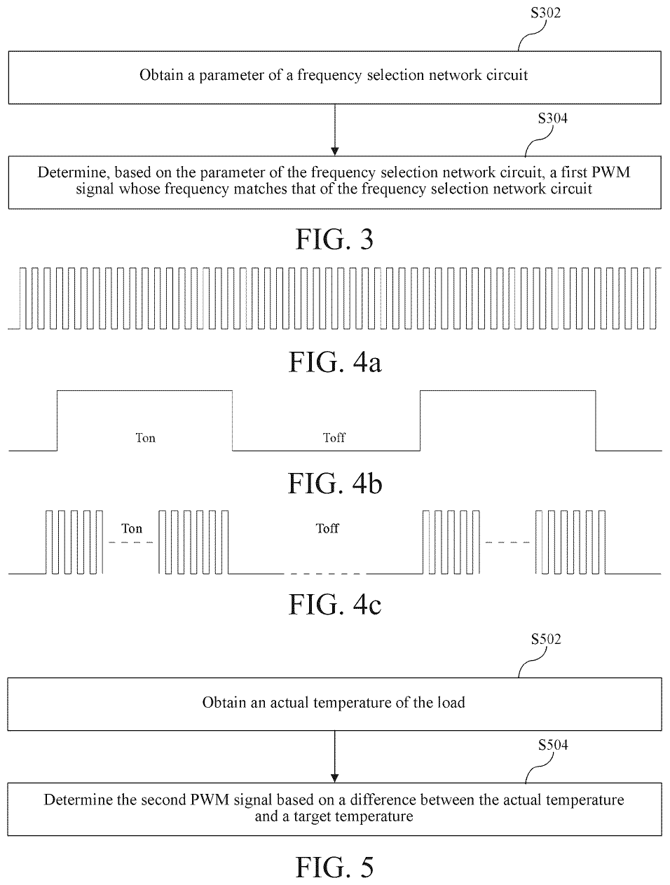

The step of determining the first PWM signal, as shown in FIG. 3, includes the following steps:
S302: Obtain a parameter of a frequency selection network circuit.
S304: Determine, based on the parameter of the frequency selection network circuit, a first PWM signal whose frequency matches that of the frequency selection network circuit.

The PWM signal satisfying the reliable turn-on or turn-off of the first switch module is determined by a frequency selection network. An amplitude of the first PWM signal may be determined based on a situation of an on voltage and an end-off voltage required for maintaining the first switch module to be turned on/off. Based on above, a specific frequency range of the first PWM signal is determined within a specific frequency range, for example, under a constraint condition that the frequency of the first PWM signal is greater than the frequency of the second PWM signal. In the specific frequency range, based on the parameter of the frequency selection network circuit, the reliable turn-on and turn-off of the first switch module at a specific frequency are achieved.

To help a person skilled in the art better understand the solution, reference is made to the circuit structure shown in FIG. 1. In the circuit structure, the first PWM signal inputted by the control terminal of the first switch transistor Q1 is determined by a frequency selection network circuit composed of C1/D1/D2/R1/R2/C2. Based on a required frequency range (which satisfies the above magnitude relationship with the frequency of the second PWM signal), the parameter of C1/D1/D2/R1/R2/C2 is appropriately matched, to achieve reliable transmission of the electrical signal to the second switch module within the specific frequency range, so as to stably drive the second switch module to be turned on or off.

For the electric heating appliance such as the aerosol generation device, during the determining of the target PWM signal of the load such as the heating assembly thereof, when the frequency of the first PWM signal is not less than 5 times the frequency of the second PWM signal, the stable on/off control of the two modules can be ensured.

In an embodiment, the determining and outputting a target PWM signal based on the first PWM signal and the second PWM signal includes:
performing an AND operation on the first PWM signal and the second PWM signal, and determining and outputting the target PWM signal.

The AND operation may be performed on the first PWM signal and the second PWM signal by using an AND logic device or software, and a result of the AND operation is used as the target PWM signal, as shown in FIG. 4a to FIG. 4c. For the structure of FIG. 1, a first PWM signal shown in FIG. 4a and a second PWM signal shown in FIG. 4b are determined based on the determined target operating parameter of the load. A target PWM signal shown in FIG. 4c is obtained based on the two signals. Under an action of the target PWM signal, during a high-level time period shown in FIG. 4b, the first switch transistor Q1 is normally turned on, and transmits the electrical signal to the gate of the second switch transistor Q2, to trigger the Q2 to be turned on. The power supply voltage acts on the drain of the Q2 through the source of the Q2, and is loaded onto the load to supply power to the load. In a continuous low level range of the target PWM signal (corresponding to a low-level time period in FIG. 4b), the first switch transistor Q1 is turned off under an action of a low level introduced by the base, and disconnects the transmission of the electrical signal to the control terminal of the Q2. In this case, the Q2 is turned off, the power supply voltage cannot be loaded onto the load, and the load is de-energized. In this way, the power outputted by the Q2 to the load may be precisely controlled through load the target PWM signal for a plurality of periods. In addition, during entire power regulation, a problem of a control failure as a result of the target PWM signal being not adapted to the on/off condition of each of the first switch transistor Q1 and the second switch transistor Q2 does not need to be worried, and reliability is high. It should be noted that dash lines in FIG. 4c indicate omission, and mean that a middle waveform thereof is consistent with a front waveform and a rear waveform. In other words, a waveform in a time period Ton in FIG. 4c is a waveform shown in FIG. 4a, and a waveform in a time period Toff in FIG. 4b is maintained in the time period Toff.

In an embodiment, the target operating parameter includes a target temperature. As shown in FIG. 5, the determining a second PWM signal based on the target operating parameter includes the following steps:
S502: Obtain an actual temperature of the load. The actual temperature of the load refers to temperature data reflecting a current heating situation of the load. The data may be measured through a temperature sensor. When the load is a heating device, the resistance value thereof has an association relationship with the temperature. In this case, the temperature may alternatively be determined based on resistance measurement. In the implementation, the temperature sensor does not need to be introduced, which saves costs.
S504: Determine the second PWM signal based on a difference between the actual temperature and a target temperature.

The regulation is intended to stabilize the load at the target temperature, so as to perform constant temperature heating on a substance such as an aerosol-forming substrate, or the regulation is intended to stabilize the load at the target temperature, so as to provide stable heating. Based on the second PWM signal that has been loaded onto the second switch module, the regulation of the output power loaded onto the load can be achieved by increasing or decreasing the duty cycle of the second PWM signal, thereby changing the operating temperature of the load. Therefore, the second PWM signal may be re-determined based on the difference between the actual temperature and the target temperature. Based on the second PWM signal determined in the manner, and the target PWM signal obtained after the AND logical operation is performed on the first PWM signal, the load can be quickly controlled to adjust to the target temperature. In this way control precision is high and a response is quick.

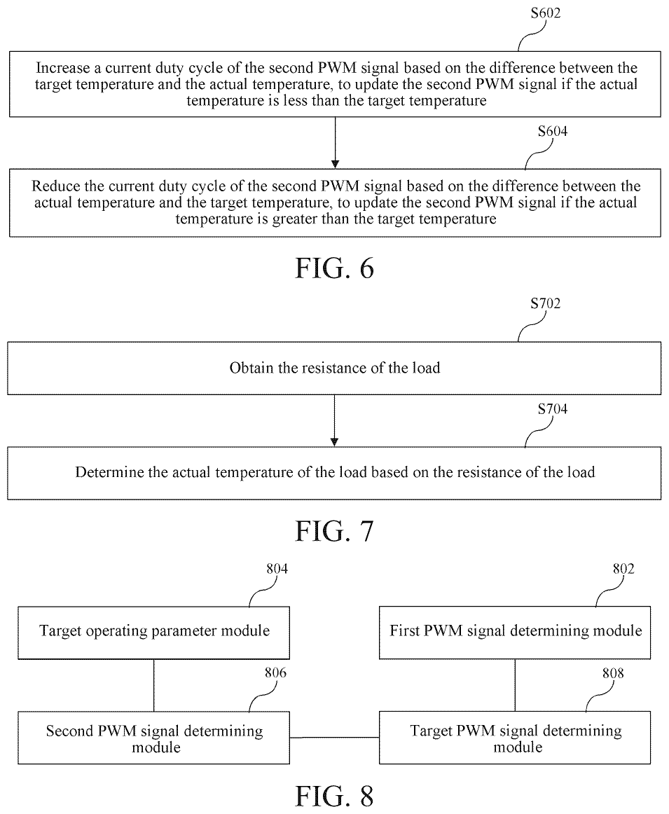

In an embodiment, as shown in FIG. 6, the determining the second PWM signal based on a difference between the actual temperature and the target temperature includes the following steps:
S602: Increase a current duty cycle of the second PWM signal based on the difference between the target temperature and the actual temperature, to update the second PWM signal if the actual temperature is less than the target temperature. In addition/alternatively,
S604: Reduce the current duty cycle of the second PWM signal based on the difference between the actual temperature and the target temperature, to update the second PWM signal if the actual temperature is greater than the target temperature. A degree of increase is positively correlated with the difference between the target temperature and the actual temperature, and a degree of reduction is positively correlated with the difference between the actual temperature and the target temperature.

A larger difference from the target temperature means that a larger duty cycle needs to be adjusted. Therefore, in a case that the actual temperature is less than the target temperature, based on the positive correlation, an amount of a current duty cycle of the second PWM signal that needs to be increased is determined based on the difference between the target temperature and the actual temperature greater than 0, and the second PWM signal is updated based on the amount that needs to be increased, to determine, as a new second PWM signal, a new target PWM signal, which is configured to be loaded onto the control terminal of the first switch module. After the new target PWM signal is loaded onto the control terminal of the first switch module, the second switch module may prolong an on time of the second switch module based on the increased duty cycle, to increase the power outputted by the second switch module to the load, so that the operating power of the load is increased, and the temperature quickly reaches the target temperature. Similarly, in a case that the actual temperature is greater than the target temperature, a second PWM signal with a reduced duty cycle may be determined through a reverse adjustment, and then the step of determining and outputting the target PWM signal based on the first PWM signal and the second PWM signal is re-performed based on the updated second PWM signal. In other words, after each update of the second PWM signal, the step is performed to determine a new target PWM signal, to change the power of the load, so that the temperature of the load is quickly stabilized at the target temperature.

The adjustment may be continuously performed based on the obtaining of the target temperature and the actual temperature when the target temperature is constant. In addition, when the target operating parameter such as the target temperature changes, the load may be controlled to quickly operate at the new target operating parameter based on the control method provided in this embodiment of this application while ensuring that the first switch module and the second switch module are stably turned on or off.

In an embodiment, as shown in FIG. 7, the obtaining an actual temperature of the load includes the following steps:
S702: Obtain the resistance of the load.
S704: Determine the actual temperature of the load based on the resistance of the load.

For the load such as the heating assembly that has an increase in the resistance as the temperature increases, a definite relationship exists between the resistance and the actual temperature of the load. The relationship may be learned in advance based on a temperature and resistance test experiment of the load. Based on the above, the resistance of the load may be obtained during operation. The resistance herein refers to a resistance value, so that the actual temperature of the load is determined Based on the resistance and the resistance-actual temperature relationship. A plurality of existing electric heating appliances have voltage sampling circuits and current sampling circuits. Based on above, the resistance of the load may be calculated based on a sampled voltage and a sampling current by using Ohm's law. Based on an original circuit structure, a temperature sensor does not need to be added to perform temperature measurement, which helps reduce product costs.

Certainly, the actual temperature of the load may alternatively be obtained through the temperature sensor. Details are not described herein.

It should be understood that, although the steps in the flowcharts involved in the embodiments described above are displayed in sequence as indicated by arrows, these steps are not necessarily performed in sequence as indicated by the arrows. Unless otherwise explicitly specified in this application, execution of the steps is not strictly limited, and the steps may be performed in another sequence. In addition, at least some of the steps in the flowcharts involved in the embodiments described above may include a plurality of steps or a plurality of stages. The steps or stages are not necessarily performed at the same moment but may be performed at different moments. These steps or stages are not necessarily successively performed, but may be performed alternately with other steps or at least some of steps or stages of other steps.

Based on the same inventive concept, an embodiment of this application further provides a control device for an electric heating appliance for implementing the control method for an electric heating appliance involved above. An implementation provided by the device to resolve the problem is similar to the implementation described in the above method. Therefore, for specific limitations in one or more embodiments of the control device for an electric heating appliance provided below, reference may be made to the limitations of the above control method for an electric heating appliance. Details are not described herein.

In an embodiment, as shown in FIG. 8, a control device for an electric heating appliance is provided. The electric heating appliance includes a first switch module, a second switch module, and a load. A control terminal of the first switch module is configured to access a target PWM signal. An output terminal of the first switch module is connected to a control terminal of the second switch module. An input terminal of the second switch module is configured to access a power supply voltage. An output terminal of the second switch module is connected to the load. An output signal of the first switch module is configured to control the second switch module to be in an on state or an off state.

In an embodiment, the control device for an electric heating appliance includes:
a first PWM signal determining module 802, configured to determine a first PWM signal, where the first PWM signal is a signal loaded onto the control terminal of the first switch module in a state in which the first switch module operates independently, to drive the first switch module to perform reliable on/off switching;
a target operating parameter module 804, configured to obtain a target operating parameter of the load;
a second PWM signal determining module 806, configured to determine a second PWM signal based on the target operating parameter, where the second PWM signal is a signal loaded onto the control terminal of the second switch module to drive the second switch module to be turned on or off, to cause the load to operate based on the target operating parameter; and
a target PWM signal determining module 808, configured to determine and output the target PWM signal based on the first PWM signal and the second PWM signal, to cause the load to operate based on the target operating parameter, where
the frequency of the first PWM signal is greater than the frequency of the second PWM signal.

For the meanings of nouns, reference may be made to the description in the above method embodiments. Details are not described herein again.

The first PWM signal determining module 802 determines the first PWM signal and sends the first PWM signal to the target PWM signal determining module 806. The first PWM signal is a signal loaded onto the control terminal of the first switch module in a state in which the first switch module operates independently, to drive the first switch module to perform reliable on/off switching. Then the target operating parameter module 804 obtains the target operating parameter of the load and sends the target operating parameter to the second PWM signal determining module 806. The second PWM signal determining module 806 determines the second PWM signal based on the target operating parameter, and sends the second PWM signal to the target PWM signal determining module 808. The second PWM signal is a signal loaded onto the control terminal of the second switch module to drive the second switch module to be turned on or off, to cause the load to operate based on the target operating parameter. Finally, the target PWM signal determining module 808 determines and outputs the target PWM signal based on the first PWM signal and the second PWM signal, to cause the load to operate based on the target operating parameter.

In an embodiment, the first switch module includes a first switch transistor and a frequency selection network circuit. An input terminal of the frequency selection network circuit is configured to access the target PWM signal, an output terminal of the frequency selection network circuit is connected to an input terminal of the first switch transistor, and an output terminal of the first switch transistor is connected to the control terminal of the second switch module.

The first PWM signal determining module 802 includes:
a frequency selection network circuit parameter obtaining unit, configured to obtain the parameter of the frequency selection network circuit;
a first PWM signal calculation unit, configured to determine, based on the parameter of the frequency selection network circuit, a first PWM signal whose frequency matches that of the frequency selection network circuit.

In an embodiment, the target PWM signal determining module 808 includes:

a target PWM signal determining unit, configured to perform an AND operation on the first PWM signal and the second PWM signal, and determine and output the target PWM signal.

In an embodiment, the target operating parameter includes a target temperature. The second PWM signal determining module 806 includes:
an actual temperature obtaining unit, configured to obtain an actual temperature of the load; and
a second PWM signal determining unit, configured to determine the second PWM signal based on a difference between the actual temperature and the target temperature.

In an embodiment, the second PWM signal determining unit includes a power increase unit and a power reduction unit.

The power increase unit is configured to increase a current duty cycle of the second PWM signal based on the difference between the target temperature and the actual temperature, to update the second PWM signal when the actual temperature is less than the target temperature. In addition/alternatively,

the power reduction unit is configured to reduce the current duty cycle of the second PWM signal based on the difference between the actual temperature and the target temperature, to update the second PWM signal when the actual temperature is greater than the target temperature.

A degree of increase is positively correlated with the difference between the target temperature and the actual temperature, and

a degree of reduction is positively correlated with the difference between the actual temperature and the target temperature.

In an embodiment, the actual temperature obtaining unit includes:
a resistance obtaining unit, configured to obtain the resistance of the load; and
a temperature determining unit, configured to determine the actual temperature of the load based on the resistance of the load.

All or some of the modules in the above control device for an electric heating appliance may be implemented by software, hardware, or a combination thereof. The above modules may be built in or independent of a processor of a controller in a form of hardware, or may be stored in a memory of the controller in a form of software, so that the processor invokes each of the above modules to perform an operation corresponding to the module.

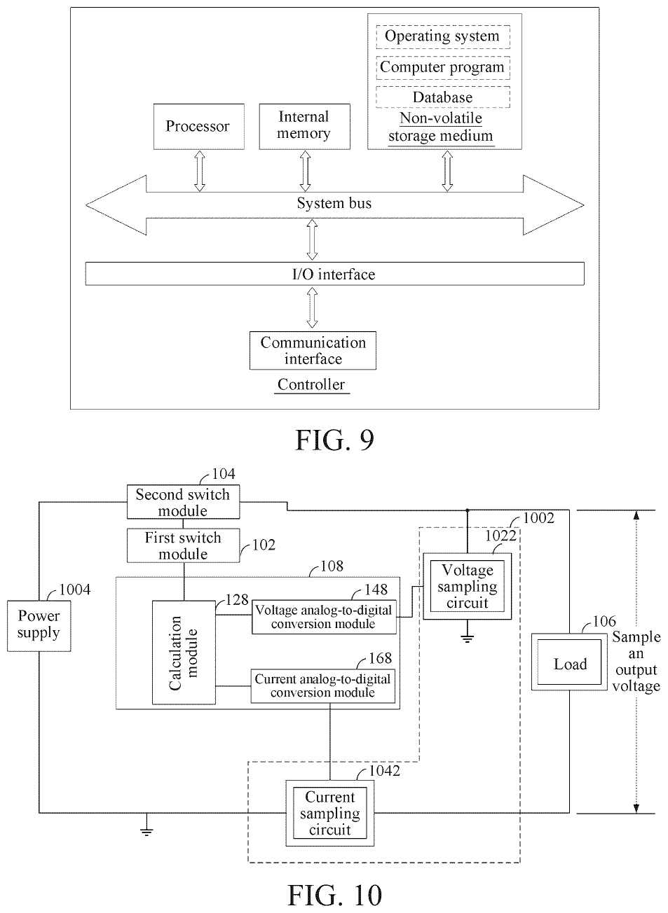

In an embodiment, a controller is provided. The controller may be a server, and an internal structure diagram thereof may be shown in FIG. 9. The controller includes a processor, a memory, and a network interface connected through a system bus. The processor of the controller is configured to provide computing and control capabilities. The memory of the controller includes a non-volatile storage medium and an internal memory. The non-volatile storage medium stores an operating system, computer-readable instructions, and a database. The internal memory provides an environment for running of the operating system and the computer-readable instructions in the non-volatile storage medium. The database of the controller is configured to store data such as a first PWM signal. The network interface of the controller is configured to connect and communicate with an external terminal through a network. The computer-readable instructions, when executed by the processor, implement a control method for an electric heating appliance.

A person skilled in the art may understand that the structure shown in FIG. 9 is merely a block diagram of a partial structure related to the solution of this application, and does not constitute a limitation on the controller to which the solution of this application is applied. The controller may include more or fewer components than those shown in the figure, or some merged components, or different component arrangements.

This application further provides a controller, including a memory and a processor. The memory stores computer-readable instructions. The computer-readable instructions, when executed by the processor, cause the processor to perform the steps of the above control method for an electric heating appliance, and to achieve corresponding beneficial effects. The controller may be an integrated chip, or may be an integrated circuit composed of logic devices.

This application further provides an electric heating appliance, as shown in FIG. 1, including a first switch module, a second switch module, a load, and a controller. A control terminal of the first switch module is configured to access a target PWM signal. A control terminal of the second switch module is connected to an output terminal of the first switch module, an input terminal of the second switch module is configured to access a power supply voltage, and the second switch module is configured to be in an on state or an off state under an action of an output signal of the first switch module. The load is connected to an output terminal of the second switch module. In addition, an output terminal of the controller is connected to the control terminal of the first switch module, to form the circuit structure as shown in FIG. 1, and the controller is configured to perform the steps of the above control method during operation.

The controller determines a first PWM signal that can ensure stable on/off control of the first switch module by performing the above method, to ensure the stable on/off control of the first switch module when independently operating. Then the target operating parameter of the load is obtained, to determine a duty cycle at which the second switch module needs to operate when the load is required to operate based on the target operating parameter, so that it can be ensured that the load stably operates based on the target operating parameter. Based on the determined first PWM signal and second PWM signal determined, a target PWM signal that satisfies both the stable on/off control of the first switch module and an output power requirement of the second switch module can be determined. The controller outputs the target PWM signal to the control terminal of the first switch module, to cause the load to operate based on the target operating parameter.

It should be emphasized that, in addition to the specific type selection example in FIG. 1, another type of switch may alternatively be selected for the first switch transistor Q1. The drawings are intended to help a person skilled in the art understand the implementation of the solutions, and do not impose a limitation on the protection scope of this application. The same is true for type selection of another specific element.

In an embodiment, the controller includes a sampling circuit 1002 and a calculation module 128. An input terminal of the sampling circuit 1002 is connected to the load 106. An input terminal of the calculation module 128 is connected to an output terminal of the sampling circuit 1002, an output terminal of the calculation module is connected to the control terminal of the first switch module, and the calculation module is configured to determine an actual temperature of the load 106 based on an output signal of the sampling circuit 1002, and is further configured to perform the steps of the above control method.

The sampling circuit 1002 may be implemented by using a circuit structure as shown in FIG. 10. In this manner, a temperature sensor does not need to be mounted.

During operation, a calculation module 128 in a controller 108 performs the processing processes of the above method, calculates the resistance based on an operating voltage and an operating current sampled by the sampling circuit 1002, and then determines the actual temperature based on a relationship between the resistance and the temperature. The controller re-determines a new second PWM signal based on a difference between the actual temperature and a target temperature, and further determines a new target PWM signal and output the new target PWM signal to the control terminal of the first switch module, to adjust the operating power of the load 106 and change the temperature thereof.

When the sampling circuit 1002 is shown in FIG. 10, the resistance calculation may be implemented as follows:

The calculation module outputs the target PWM signal to the first switch module 102. Under an action of the target PWM signal, the second switch module 104 is turned on or off based on the waveform shown in FIG. 4b. During a time period of which the second switch module 104 is turned on, the voltage VCC_BAT of a power supply 1004 is loaded onto the load 106, and the load 106 is energized and is heated. A voltage sampling circuit 1022 collects the operating voltage when the load 106 is heated, a current sampling circuit 1042 samples the operating current when the load 106 is heated, and the operating voltage and the operating current are respectively transmitted to the calculation module through a corresponding voltage analog-to-digital conversion module 148 and a corresponding current analog-to-digital conversion module 168. The calculation module calculates a real-time resistance of the load 106 with both the operating voltage and the operating current based on the Ohm's law, and determines the actual temperature of the load 106 based on the real-time resistance.

In an embodiment, the first switch module includes a frequency selection network circuit and a first switch transistor. An input terminal of the frequency selection network circuit is connected to the output terminal of the controller. A control terminal of the first switch transistor is connected to an output terminal of the frequency selection network circuit, and an output terminal of the first switch transistor is connected to the control terminal of the second switch module. As described in the above method embodiment, the first PWM signal adapted to the frequency of the frequency selection network circuit is determined by using the parameter of the frequency selection network circuit. In addition, when the parameter of the frequency selection network circuit is selected, the duty cycle range and the frequency of the second PWM signal may be determined based on an upper limit value and a lower limit value of the operating power of the load. A frequency change range of the first PWM signal is determined based on the frequency of the second PWM signal while ensuring that the frequency of the first PWM signal needs to be greater than the frequency of the second PWM signal. Then a frequency selection network circuit adapted to the specific frequency change range is designed based on the specific frequency change range.

For example, in the structure and the device type selection shown in FIG. 1, when the waveform in FIG. 4a adopts 5 kHz (an optimal operating frequency of the first switch transistor Q1 under certain type selection), the capacitor C1 may be 0.1 μF, the resistor R1 may be 470Ω, the resistor R2 is 51 kΩ, and the capacitor C2 is 0.22 μF, so that reliable control of the circuit can be achieved.

Theoretically, in the circuit, a larger value of the capacitor C1 is better. However, due to an economic consideration, the capacitor C1 with a relatively small value may be selected in a case that the first PWM signal has the relatively large frequency. For example, when the first PWM signal is 5 kHz, a capacitor in a range of 0.01 μF to 1 μF may be selected as the C1 in the circuit structure shown in FIG. 1, which can balance both economy and stability of on/off control of the first switch transistor.

The R1/R2/C2 forms an integrated circuit. A larger value of the capacitor C2 causes a larger delay in a turn-on/off action of the second switch transistor Q2. If the value is excessively large, a case in which the second switch transistor Q2 cannot normally output exists. However, if the capacitor C2 is excessively small, the output signal of the second switch transistor Q2 generates a large ripple, and even the output signal of the second switch transistor Q2 is no longer continuous when a high-level signal needs to be continuously outputted and loaded onto the load.

The frequency selection network circuit determined through the above design idea can not only ensure that the turn-on of the first switch transistor Q1 is fully controllable, but also ensure the precise action of the second switch transistor Q2. The output of the second switch transistor Q2 precisely achieves the waveform shown in FIG. 4b required by the load, which ensures precise temperature control of a heating element and prevents a case of dry heating or excessively slow heating of the appliance. When the frequency selection network circuit is applied to a control process of the electric heating appliance of the aerosol generation device, an atomization effect can be greatly optimized, and a user experience can be improved.

The optimum operating frequency of the first switch transistor may be modified through proper matching of the parameter of the C1/D1/D2/R1/R2/C2.

A negative-positive-negative (NPN) transistor shown in FIG. 1 may be selected as the first switch transistor, or a metal-oxide-semiconductor (MOS) transistor or another type of composite MOS transistor with the same on/off characteristic as that of the first switch transistor may be selected to replace the first switch transistor, which is not limited in the drawings of this application.

In an embodiment, the second switch module includes a second switch transistor. A control terminal of the second switch transistor is connected to an output terminal of the first switch module. An input terminal of the second switch transistor is configured to access a power supply voltage. An output terminal of the second switch transistor is connected to the load.

A P-Channel metal-oxide-semiconductor (PMOS) transistor shown in FIG. 1 may be selected as the second switch transistor, and the second switch transistor is connected based on a connection method shown in the figure. Certainly, another transistor or composite field effect transistor with the same on/off characteristic as that of the PMOS transistor may be selected to replace the second switch transistor. To improve operating stability, as shown in FIG. 1, a resistor R3 may be connected between the output terminal of the first switch transistor Q1 and the control terminal of the second switch transistor Q2. To maintain stable operation of the second switch transistor Q2, a resistor R4 may be connected between the source and the gate of the second switch transistor.

An embodiment of this application further provides a computer-readable storage medium, storing computer-readable instructions. The computer-readable instructions, when executed by a processor, implement the following steps:
S202: Determine a first PWM signal, where the first PWM signal is a signal loaded onto a control terminal of a first switch module in a state in which the first switch module operates independently, to drive the first switch module to perform reliable on/off switching.
S204: Obtain a target operating parameter of a load. The target operating parameter is a parameter expected by a user for the load during operation.
S206: Determine a second PWM signal based on the target operating parameter, where the second PWM signal is a signal loaded onto a control terminal of a second switch module to drive the second switch module to be turned on or off, to cause the load to operate based on the target operating parameter.
S208: Determine and output a target PWM signal based on the first PWM signal and the second PWM signal, to cause the load to operate based on the target operating parameter.

In an embodiment, the computer-readable instructions, when executed by the processor, further implement the following steps:
S302: Obtain a parameter of a frequency selection network circuit.
S304: Determine, based on the parameter of the frequency selection network circuit, a first PWM signal whose frequency matches that of the frequency selection network circuit.

In an embodiment, the computer-readable instructions, when executed by the processor, further implement the following steps:
performing an AND operation on the first PWM signal and the second PWM signal, and determining and outputting the target PWM signal.

In an embodiment, the computer-readable instructions, when executed by the processor, further implement the following steps:
S502: Obtain an actual temperature of the load. The actual temperature of the load refers to temperature data reflecting a current heating situation of the load.
S504: Determine the second PWM signal based on a difference between the actual temperature and a target temperature.

In an embodiment, the computer-readable instructions, when executed by the processor, further implement the following steps:
S602: Increase a current duty cycle of the second PWM signal based on the difference between the target temperature and the actual temperature, to update the second PWM signal if the actual temperature is less than the target temperature. In addition/alternatively,
S604: Reduce the current duty cycle of the second PWM signal based on the difference between the actual temperature and the target temperature, to update the second PWM signal if the actual temperature is greater than the target temperature.

A degree of increase is positively correlated with the difference between the target temperature and the actual temperature, and a degree of reduction is positively correlated with the difference between the actual temperature and the target temperature.

In an embodiment, the computer-readable instructions, when executed by the processor, further implement the following steps:
S702: Obtain the resistance of the load.
S704: Determine the actual temperature of the load based on the resistance of the load.

In an embodiment, a computer-readable instruction product is provided, including computer-readable instructions. The computer-readable instructions, when executed by a processor, implement the following steps.
S202: Determine a first PWM signal, where the first PWM signal is a signal loaded onto a control terminal of a first switch module in a state in which the first switch module operates independently, to drive the first switch module to perform reliable on/off switching.
S204: Obtain a target operating parameter of a load. The target operating parameter is a parameter expected by a user for the load during operation.
S206: Determine a second PWM signal based on the target operating parameter, where the second PWM signal is a signal loaded onto a control terminal of a second switch module to drive the second switch module to be turned on or off, to cause the load to operate based on the target operating parameter.
S208: Determine and output a target PWM signal based on the first PWM signal and the second PWM signal, to cause the load to operate based on the target operating parameter.

In an embodiment, the computer-readable instructions, when executed by the processor, further implement the following steps:
S302: Obtain a parameter of a frequency selection network circuit.
S304: Determine, based on the parameter of the frequency selection network circuit, a first PWM signal whose frequency matches that of the frequency selection network circuit.

In an embodiment, the computer-readable instructions, when executed by the processor, further implement the following steps:
performing an AND operation on the first PWM signal and the second PWM signal, and determining and outputting the target PWM signal.

In an embodiment, the computer-readable instructions, when executed by the processor, further implement the following steps:
S502: Obtain an actual temperature of the load. The actual temperature of the load refers to temperature data reflecting a current heating situation of the load.
S504: Determine the second PWM signal based on a difference between the actual temperature and a target temperature.

In an embodiment, the computer-readable instructions, when executed by the processor, further implement the following steps:
S602: Increase a current duty cycle of the second PWM signal based on the difference between the target temperature and the actual temperature, to update the second PWM signal if the actual temperature is less than the target temperature. In addition/alternatively,
S604: Reduce the current duty cycle of the second PWM signal based on the difference between the actual temperature and the target temperature, to update the second PWM signal if the actual temperature is greater than the target temperature.

A degree of increase is positively correlated with the difference between the target temperature and the actual temperature, and a degree of reduction is positively correlated with the difference between the actual temperature and the target temperature.

In an embodiment, the computer-readable instructions, when executed by the processor, further implement the following steps:
S702: Obtain the resistance of the load.
S704: Determine the actual temperature of the load based on the resistance of the load.

It should be noted that the user information (including but not limited to user device information and user personal information) and data (including but not limited to data for analysis, stored data, and displayed data) involved in this application are all authorized by the user or information and data fully authorized by all parties.

A person of ordinary skill in the art may understand that all or some processes of the method in the above embodiments may be implemented by computer-readable instructions by instructing relevant hardware. The computer-readable instructions may be stored in a non-volatile computer-readable storage medium. When the computer-readable instructions are executed, the processes of the above method embodiment can be implemented. Any reference to a memory, a database, or another medium used in the embodiments provided in this application may include at least one of a non-volatile memory or a volatile memory. The non-volatile memory may include a read-only memory (ROM) a magnetic tape, a floppy disk, a flash memory, an optical memory, a high density embedded non-volatile memory, a resistive memory (ReRAM), a magnetoresistive random access memory (MRAM), a ferroelectric random access memory (FRAM), a phase change memory (PCM), a graphene memory, and the like. The non-volatile memory may include a random access memory (RAM) an external cache, or the like. For the purpose of description instead of limitation, the RAM is available in a plurality of forms, such as a static RAM (SRAM) or a dynamic RAM (DRAM). The database involved in the embodiments provided in this application may include at least one of a relational database and a non-relational database. The non-relational database may include a block-chain-based distributed database, and the like, but is not limited thereto. The processor involved in the embodiments provided in this application may be a general purpose processor, a central processing unit, a graphics processing unit, a digital signal processor, a programmable logic device, a data processing logic device based on quantum computing, or the like, but is not limited thereto.

The technical features of the above embodiments may be randomly combined. To make the description concise, not all possible combinations of the technical features in the above embodiments are described. However, the combinations of these technical features shall be considered as falling within the scope recorded in this specification provided that no conflict exists.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A control method for an electric heating appliance having a first switch module, a second switch module, and a load, a control terminal of the first switch module being configured to access a target pulse width modulation (PWM) signal, an output terminal of the first switch module being connected to a control terminal of the second switch module, an input terminal of the second switch module being configured to access a power supply voltage, an output terminal of the second switch module being connected to the load, and an output signal of the first switch module being configured to control the second switch module to be in an on state or an off state, the method comprising:
determining a first PWM signal, the first PWM signal comprising a signal loaded onto the control terminal of the first switch module in a state in which the first switch module operates independently, so as to drive the first switch module to perform on/off switching;
obtaining a target operating parameter of the load;
determining a second PWM signal based on the target operating parameter, the second PWM signal comprising a signal loaded onto the control terminal of the second switch module to drive the second switch module to be turned on or off, so as to cause the load to operate based on the target operating parameter; and
determining and outputting the target PWM signal based on the first PWM signal and the second PWM signal, so as to cause the load to operate based on the target operating parameter,
wherein a frequency of the first PWM signal is greater than a frequency of the second PWM signal.

2. The method of claim 1, wherein the first switch module comprises a first switch transistor and a frequency selection network circuit,
wherein an input terminal of the frequency selection network circuit is configured to access the target PWM signal,
wherein an output terminal of the frequency selection network circuit is connected to an input terminal of the first switch transistor,
wherein an output terminal of the first switch transistor is connected to the control terminal of the second switch module, and
wherein determining the first PWM signal comprises:
obtaining a parameter of the frequency selection network circuit; and
determining, based on the parameter of the frequency selection network circuit, the first PWM signal whose frequency matches that of the frequency selection network circuit.

3. The method of claim 1, wherein determining and outputting the target PWM signal based on the first PWM signal and the second PWM signal comprises:
performing an AND operation on the first PWM signal and the second PWM signal, and determining and outputting the target PWM signal.

4. The method of claim 1, wherein the target operating parameter comprises a target temperature, and
wherein determining the second PWM signal based on the target operating parameter comprises:
obtaining an actual temperature of the load; and
determining the second PWM signal based on a difference between the actual temperature and the target temperature.

5. The method of claim 4, wherein determining the second PWM signal based on the difference between the actual temperature and the target temperature comprises:
increasing a current duty cycle of the second PWM signal based on the difference between the target temperature and the actual temperature, so as to update the second PWM signal if the actual temperature is less than the target temperature, and/or
reducing the current duty cycle of the second PWM signal based on the difference between the actual temperature and the target temperature, so as to update the second PWM signal if the actual temperature is greater than the target temperature,
wherein a degree of increase is positively correlated with the difference between the target temperature and the actual temperature, and
wherein a degree of reduction is positively correlated with the difference between the actual temperature and the target temperature.

6. The method of claim 4, wherein obtaining the actual temperature of the load comprises:
obtaining a resistance of the load; and
determining the actual temperature of the load based on the resistance of the load.

7. A control device for an electric heating appliance having a first switch module, a second switch module, and a load, a control terminal of the first switch module being configured to access a target PWM signal, an output terminal of the first switch module being connected to a control terminal of the second switch module, an input terminal of the second switch module being configured to access a power supply voltage, an output terminal of the second switch module being connected to the load, and an output signal of the first switch module being configured to control the second switch module to be in an on state or an off state, the control device comprising:
a first PWM signal determining module configured to determine a first PWM signal, the first PWM signal comprising a signal loaded onto the control terminal of the first switch module in a state in which the first switch module operates independently, so as to drive the first switch module to perform on/off switching;
a target operating parameter module configured to obtain a target operating parameter of the load;
a second PWM signal determining module configured to determine a second PWM signal based on the target operating parameter, the second PWM signal comprising a signal loaded onto the control terminal of the second switch module to drive the second switch module to be turned on or off, so as to cause the load to operate based on the target operating parameter; and
a target PWM signal determining module configured to determine and output the target PWM signal based on the first PWM signal and the second PWM signal, so as to cause the load to operate based on the target operating parameter,
wherein a frequency of the first PWM signal is greater than a frequency of the second PWM signal.

8. A controller, comprising:
a memory; and
one or more processors,
wherein the memory stores processor-executable instructions, wherein the processor-executable instructions, when executed by the one or more processors, cause the one or more processors to perform the method of claim 1.

9. An electric heating appliance, comprising:
a first switch module, a control terminal of the first switch module being configured to access a target PWM signal;
a second switch module, a control terminal of the second switch module being connected to an output terminal of the first switch module, an input terminal of the second switch being configured to access a power supply voltage, and the second switch module being configured to be in an on state or an off state under an action of an output signal of the first switch module;
a load connected to the output terminal of the second switch module; and
a controller, an output terminal of the controller being connected to the control terminal of the first switch module.

10. The electric heating appliance of claim 9, wherein the controller comprises:
a sampling circuit, an input terminal of the sampling circuit being connected to the load; and
a calculation module, an input terminal of the calculation module being connected to an output terminal of the sampling circuit, an output terminal of the calculation module being connected to the control terminal of the first switch module, and the calculation module being configured to determine an actual temperature of the load based on an output signal of the sampling circuit.

11. The electric heating appliance of claim 9, wherein the first switch module comprises:
a frequency selection network circuit, an input terminal of the frequency selection network circuit being connected to the output terminal of the controller; and
a first switch transistor, a control terminal of the first switch transistor being connected to an output terminal of the frequency selection network circuit, and an output terminal of the first switch transistor being connected to the control terminal of the second switch module.

12. The electric heating appliance of claim 9, wherein the second switch module comprises:
a second switch transistor, a control terminal of the second switch transistor being connected to the output terminal of the first switch module, an input terminal of the second switch transistor being configured to access the power supply voltage, and an output terminal of the second switch transistor being connected to the load.
